(19) United States
(12) Patent Application Publication
(10) Pub. No.: US 2007/0012370 A1
(43) Pub. Date: Jan. 18, 2007

(54) Facetted high temperature thruster design

(75) Inventors: Donald J. Christensen, Phoenix, AZ (US); Lowell W. Munson, Tempe, AZ (US); Ronald J. Marusiak, Tempe, AZ (US)

Correspondence Address: HONEYWELL INTERNATIONAL INC., 101 COLUMBIA ROAD, P O BOX 2245, MORRISTOWN, NJ, 07962-2245, US

(73) Assignees: Honeywell International, Inc.; Micro-Tronics, Inc.; GPS Aerospace, Inc.

(21) Appl. No.: 11/184,600

(22) Filed: Jul. 18, 2005

(51) Int. Cl. F15C 3/00

(52) U.S. Cl. 137/829

(57) ABSTRACT

An apparatus and method for manufacturing the apparatus is provided as a thruster for use with a fluidic diverter valve, the fluidic diverter valve having a valve housing. The thruster has a first tube, a valve seat, and a flow path. The first tube has a first end, a second end, and an outer surface. The first tube first end is configured to be disposed within the valve housing and the outer surface has a valve seat section and a blast tube section. The valve seat section is adapted to couple to the valve housing and the blast tube section is configured to extend outside of the valve housing. The valve seat is integrally formed on the first tube first end. The flow path extends between the first tube first and second ends.

### TECHNICAL FIELD

The present invention relates to hot gas fluidic diverter valves used in missile and spacecraft propulsion systems and, more particularly, to a hot gas fluidic diverter valve that has a thruster for use in high temperature applications.

### BACKGROUND

The movements involved in flight of some missiles and space vehicles, such as pitch, yaw, and spin rate, are controlled with flight control systems that use reaction jets. In some systems of this type, a pressurized gas source, such as a gas generator, supplies a pressurized gas to one or more fluidic amplifier stages. In response to a control signal supplied from flight control equipment, a fluidic amplifier stage can selectively divert the pressurized gas into one of two or more flow paths. Each flow path may extend through a thruster and may have a nozzle coupled to the thruster that is located external to the missile or vehicle. These nozzles may be positioned to provide thrust in different or opposite directions. Thus, the fluidic amplifier stages can affect one or more flight parameters by selectively diverting the pressurized gas to selected outlet nozzles.

The fluidic amplifier stages incorporated into the above-described flight control system can include a fluidic diverter valve, between the final fluidic amplifier stage and the output nozzles, which allows the system to substantially achieve 100% flow diversion. One particular type of fluidic diverter valve uses a valve element. The valve element is located in a chamber formed in the valve housing. The housing includes an inlet port and two outlet ports. Each of the two outlet ports includes a valve seat against which the valve element may seat to selectively block one of the two ports so that pressurized gas entering the inlet port is selectively directed out the port that is not blocked. The two outlet ports each provide entry into a flow path formed in a blast tube that communicates with its corresponding output nozzle.

To accurately control the movements of the missile or vehicle, the outlet port, blast tube flow path, and nozzle need to maintain their precise shapes and a substantially exact alignment so that the pressurized gases may be appropriately diverted in a desired direction. Conventionally, the blast tube and nozzle are integrally formed into a blast tube/nozzle component. In this regard, a chemical vapor deposition (“CVD”) process is used to deposit a desired material, such as a rhenium alloy, onto a mandrel having a shape of the desired flow path. After a sufficient thickness of the material is deposited, the blast tube/nozzle component is machined to a desired shape and the mandrel is dissolved out of the flow path. The valve seat is separately manufactured and subsequently welded onto one end of the blast tube/nozzle component.

Although the above-described type of fluidic diverter valve is robustly designed and manufactured, and operates safely, it suffers certain drawbacks. For example, the manufacturing method may be fairly time-consuming and costly. Additionally, when CVD is used to construct the blast tube/nozzle component, the deposited material may be relatively porous, which may cause pressurized gas to leak through the blast tube/nozzle component. Moreover, in rare instances, the valve seat may not be properly aligned with the blast tube/nozzle component, which may cause the fluidic diverter valve to operate improperly.

Hence there is a need for a fluidic diverter valve that addresses one or more of the above-noted drawbacks. Namely, a hot gas fluidic diverter valve having a design and method of manufacture that is not complex and/or costly, and/or is structurally robust. The present invention addresses one or more of these needs.

### BRIEF SUMMARY

The present invention provides a thruster for use with a fluidic diverter valve, the fluidic diverter valve having a valve housing. The thruster has a first tube, a valve seat, and a flow path. The first tube has a first end, a second end, and an outer surface. The first tube first end is configured to be disposed within the valve housing and the outer surface has a valve seat section and a blast tube section. The valve seat section is adapted to couple to the valve housing and the blast tube section is configured to extend outside of the valve housing. The valve seat is integrally formed on the first tube first end. The flow path extends between the first tube first and second ends.

In one embodiment, and by way of example only, a hot gas fluidic diverter valve is provided. The valve includes a valve housing and a thruster. The valve housing has a cavity formed therethrough. The thruster is coupled to the valve housing and includes a first tube, a valve seat, a flow path, and a separately manufactured nozzle. The first tube has a first end, a second end, and an outer surface. The first tube first end is disposed within the valve housing cavity and the outer surface has a valve seat section and a blast tube section. The valve seat section is coupled to the valve housing and the blast tube section extends outside of the valve housing. The valve seat is integrally formed on the first tube first end. The flow path extends between the first tube first and second ends. The separately manufactured nozzle is coupled to the first tube second end and has a funnel-shaped flow path extending therethrough in communication with the first tube flow path.

In another exemplary embodiment, a method for manufacturing the thruster is provided. The method includes the steps of forming a flow path through a first piece of material, shaping a first section of an outer surface of the first piece of material proximate a first end of the first piece of material to form a valve seat section configured to couple to the valve housing, using an electrical discharge machine (“EDM”) to shape a second section of the outer surface of the first piece of material between the valve seat section and a second end of the first piece of material into a blast tube section, and coupling a nozzle to the second end of the first piece of material.

Other independent features and advantages of the preferred thruster will become apparent from the following detailed description, taken in conjunction with the accompanying drawings which illustrate, by way of example, the principles of the invention.

### BRIEF DESCRIPTION OF THE DRAWINGS

FIG. 1 is a simplified schematic diagram of an exemplary flight control system that may use an embodiment of the present invention;

FIG. 2 is a cross section view of a portion of the flight control system of FIG. 1, showing an exemplary fluidic diverter valve according to one embodiment of the present invention.

FIG. 3 is an isometric view of an exemplary thruster that may be implemented into the fluidic diverter valve illustrated in FIG. 2;

FIG. 4 is a cross section view of an exemplary thruster illustrated in FIG. 3; and

FIG. 5 is a flow chart depicted an exemplary method for manufacturing the thruster illustrated in FIGS. 3 and 4.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

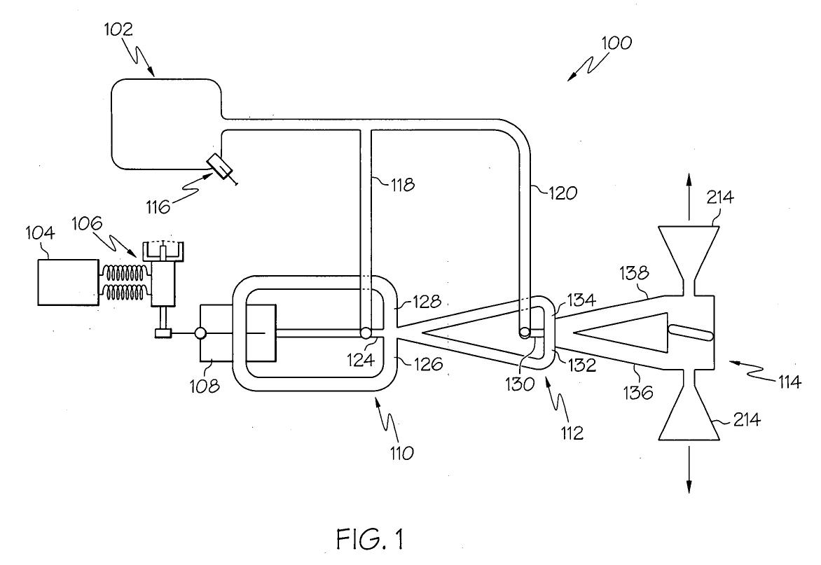

A simplified schematic diagram of at least a portion of an exemplary flight control system 100 that may use an embodiment of the present invention is illustrated in FIG. 1. The system 100 includes a gas generator 102, a flight controller 104, a solenoid valve 106, a pilot valve 108, a first stage fluidic amplifier 110, a second state fluidic amplifier 112, and a fluidic diverter valve 114. The gas generator 102 includes an initiator 116 that, during a vehicle launch sequence or at some point during vehicle flight, activates the gas generator 102. The gas generator 102, upon activation, supplies a flow of high pressure, high temperature gas to one or more gas flow paths. In the depicted embodiment, a first gas flow path 118 is fluidly coupled to the first stage fluidic amplifier 110 and to the pilot valve 108, and a second gas flow path 120 is fluidly coupled to the second stage fluidic amplifier 112.

The first 110 and second 112 stage fluidic amplifiers are each preferably non-vented fluidic bi-stable or proportional amplifiers. The first stage fluidic amplifier 110 includes a primary gas flow path 124, and two control gas flow paths, namely a first control gas flow path 126 and a second control gas flow path 128. Similarly, the second stage fluidic amplifier 112 includes a primary gas flow path 130, a first control gas flow path 132, and a second control gas flow path 134. The second stage fluidic amplifier 112 additionally includes a housing 113 having two outlet ports, a first fluid outlet port 136 and a second fluid outlet port 138.

The first stage fluidic amplifier primary gas flow path 124 is in fluid communication with the first gas flow path 118 from the gas generator 102, and the second stage fluidic amplifier primary gas flow path 130 is in fluid communication with the second gas flow path 120 from the gas generator 102. The first stage fluidic amplifier first 126 and second 128 control gas flow paths are in fluid communication with the pilot valve 108, and the second stage fluidic amplifier first 132 and second 134 control gas flow paths are in fluid communication with the first stage fluidic amplifier primary 124 gas flow path 124 and the first 126 and second 128 control gas flow paths. The second stage fluidic amplifier first 136 and second 138 fluid outlet ports are in fluid communication with the fluidic diverter valve 114.

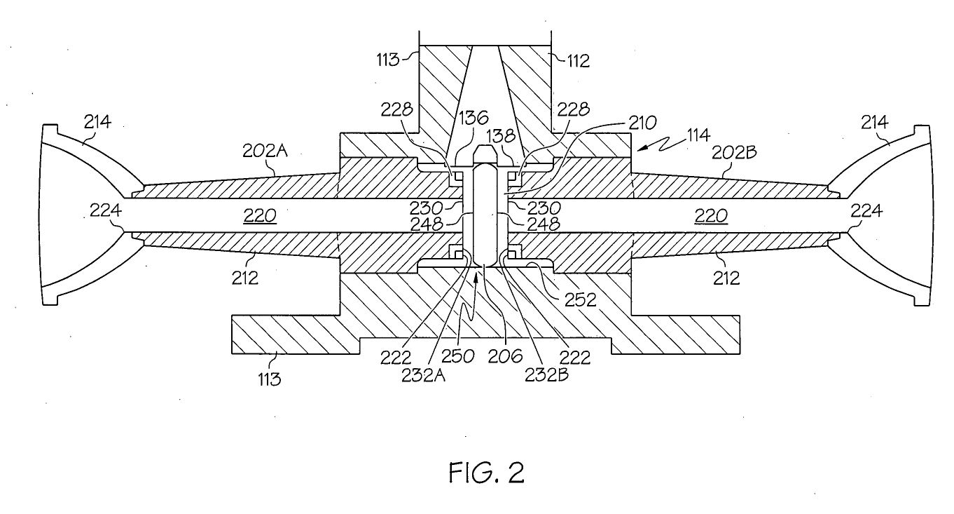

The fluidic diverter valve 114, one embodiment of which is shown in cross section in FIG. 2, is mounted to the second stage fluidic amplifier 112. In the depicted embodiment, the fluidic diverter valve 114 is mounted within the second stage fluidic amplifier housing 113, though it will be appreciated that the fluidic diverter valve 114 could be mounted on the second stage fluidic amplifier housing 113. As FIGS. 1 and 2 illustrate, the fluidic diverter valve 114 includes two thrusters 202a, 202b, and a valve element 206. The two thrusters 202a, 202b are disposed such that a valve element cavity 210 is formed therebetween to contain the valve element 206.

The thrusters 202a, 202b are each configured to receive gases from the second stage fluidic amplifier first and second fluid outlet ports 136, 138 and to divert the gases in one or more directions. In this regard, each of the two thrusters 202a, 202b includes a tube 21.2 and a nozzle 214.

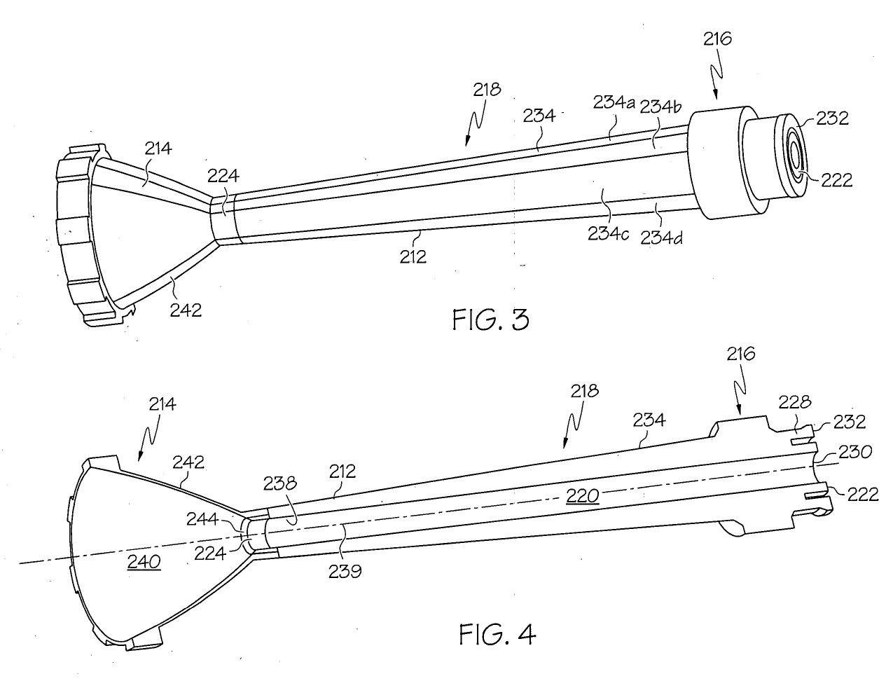

Turning now to FIGS. 3 and 4, the tube 212 includes a valve seat section 216, a blast tube section 218, and a flowpath 220. The valve seat section 216, and blast tube section 218 are each disposed between a first end 222 and a second end 224 of the tube 212 and the flowpath 220 extends through each of the valve seat section 216 and blast tube section 218 between the first and second ends 222, 224.

The valve seat section 216 is configured to receive gases and to provide a surface against which the valve element 206 may selectively seat. In this regard, the valve seat section 216 includes one or more fluid inlet ports 228, a fluid outlet port 230, and a valve seat 232. The fluid inlet ports 228 are configured to fluidly communicate with one of the second stage fluidic amplifier first and second fluid outlet ports 136, 138 and to receive fluids therefrom. The fluid inlet ports 228 may be formed in any section of the valve seat section 216. Additionally, although three fluid inlet ports 228 are shown in the embodiment depicted in FIG. 3, fewer or more may be employed as well. The fluid outlet port 230 is formed on the tube first end 222 and directs received gases into the flowpath 220. The valve seat 232 is configured to contact the valve element 206 and is also formed on the tube first end 222. It will be appreciated that the valve seat 232 may have any one of numerous suitable configurations for sealing with the valve element 206.

The blast tube section 218 directs the gases received from the valve seat section 216 to the nozzle 214. The blast tube section 218 includes an outer surface 234 and tube second end 224. Preferably, the outer surface 234 is tapered from a portion proximate the valve seat section 216 to the tube second end 224 and includes a plurality of faces 234a, 234b, 234c, 234d that also extend therebetween. The plurality of facets 234a, 234b, 234c, 234d are formed on the outer surface 234 during the manufacturing process of the blast tube section 218 wherein a wire electrical discharge machining process is used. However, it will be appreciated, that the outer surface 234 may have any one of numerous other outer surface configurations, such as, for example, smooth. The tube second end 224 is configured to couple the tube 212 to the nozzle 214. In this regard, the tube second end 224 may have any one of numerous suitable shapes that mate with the nozzle 214. For example, as illustrated in FIG. 4, the tube second end 224 is part of an extension that is inserted into the nozzle 214.

As previously mentioned, the flow path 220 extends through each of the valve seat section 216 and blast tube section 218. The flow path 220 is defined by an inner surface 238 of the tube 212 and may have any one of numerous configurations. Preferably, however, the flow path 220 extends in a substantially straight manner from the tube first end 222 to the tube second end 224. In one exemplary embodiments the flow path 220 is formed around a single longitudinal axis 239 such that the gases travel directly from the tube first end 222 to the tube second end 224 with minimal deflection off of the tube inner surface 238.

The nozzle 214 receives gases from the flow path 220 and provides an outlet through which gases are exhausted. The nozzle 214 is coupled to the tube second end 224 and includes a funnel passage 240 and outer surface 242. The funnel passage 240 extends the length of the nozzle 214 and fluidly communicates with the tube flow path 220. The funnel passage 240 includes an inlet 244 which is configured to receive blast tube section end 234. The outer surface 242 may have any one of numerous configurations, and like the blast tube section 218, may be, as shown in FIG. 3, facetted, or smooth.

Turning back to FIG. 2, the valve element 206 is may have any one of numerous suitable shapes for translating within the valve element cavity 210 between the valve seats 232a, 232b. In this regard, the valve element 206 may be spherical, non-spherical, or any other shape. In one exemplary embodiment, such as illustrated in FIG. 2, the valve element 206 is disk-shaped and includes a first side 246, a second side 248, and a peripheral section 250. The first 246 and second 248 sides are substantially flat, substantially circular in cross section, and extend parallel to one another. The peripheral section 250 is located between the first 246 and second 248 sides, and is formed substantially symmetrically with respect to the first 246 and second 248 sides. In the depicted embodiment, the peripheral section 250 is substantially semi-circular in cross sectional shape, though it will be appreciated that the peripheral section 250 is not limited to this shape and could be flat or otherwise shaped as needed in a particular application. In the depicted embodiment, the valve element peripheral section 250 extends through the second stage fluidic amplifier 112 and slidingly contacts a surface 252 therein. It will be appreciated that this is merely exemplary of a particular preferred embodiment, and that the valve element 206 could also be disposed within the cavity 210 in a non-contact configuration with the second stage fluidic amplifier 112. It will be appreciated that the shape of the valve element 206 may vary depending on various other conditions and/or component configurations such as, for example, the configuration of the valve seats 232 that are to be blocked, as described above, by the valve element 206.

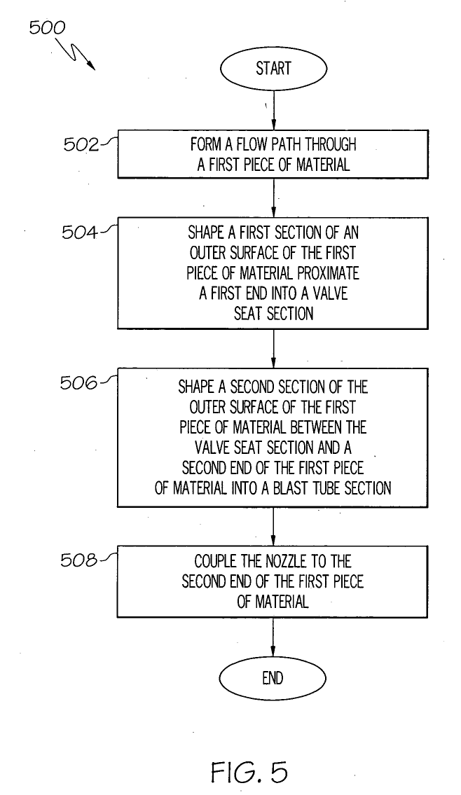

The above-mentioned thrusters 202 may be manufactured in any one of numerous manners. Turning now to FIG. 5, a flowchart illustrating an exemplary method (500) of manufacturing the thruster 202 for coupling with a valve housing 1113 is shown. The overall process (500) will first be described generally. It should be understood that the parenthetical references in the following description correspond to the reference numerals associated with the flowchart blocks shown in FIG. 5. First, the flow path 220 is formed through a first piece of material (502). Then, a first section of an outer surface of the first piece of material proximate a first end is shaped to form the valve seat section 216 (504). Next, a wire electrical discharge machine is used to shape a second section of the outer surface of the first piece of material between the valve seat section 216 and a second end of the first piece of material into a blast tube section 218 (506). Lastly, the nozzle 214 is coupled to the second end of the first piece of material (508).

Forming the flow path 220 (502) may include the steps of obtaining the first piece of material and forming the flow path 220 to extend substantially straight through the first piece of material. The first piece of material may either be obtained or specially made and may be any one of numerous types of material suitable for constructing the tube 212 of the thruster valve. Preferably, the first piece of material is material that is conventionally used during hot isostatic processes and that has a low porosity, for example, a porosity level capable of preventing pressure loss when sealed and pressurized with at least 1000 psi of nitrogen gas, and capability for maintaining structural integrity when exposed to temperatures of at least about 3,700° F. Suitable materials include rhenium alloys, tungsten alloys, molybdenum alloys, or combinations thereof. Preferably, the material is densified using a hot or a cold rolling or hot isostatic processing. The first piece of material may have any size and shape, however, the material preferably has a size and shape that is suitable for forming the tube 212 out of a single piece of material, such as, for example, rod-shaped or block-shaped.

Forming the flow path 220 may be carried out in any one of numerous manners that can be used to form a substantially straight flow path 220. To keep down the costs of a thruster, a relatively inexpensive method for forming the flow path 220 is preferably incorporated. In one exemplary embodiment, a start hole is first formed through the first piece of material. The start hole has a diameter that is smaller than a resulting diameter of the flow path 220 and may be formed in any conventional manner, such as, for example, using a plunge tool. After the start hole is formed, a wire is threaded through the hole. Then, a wire electric discharge machining (“EDM”) process is performed to carve the flow path 220 out of the first piece of material. For example, the wire is coupled to an electric discharge machine to supply electric current thereto. The wire is then used to carve the flow path 220.

Next, a first section of an outer surface of the first piece of material proximate a first end is shaped to form the valve seat section 216 (504). This step (504) may include forming the valve seat 232 at one end of the first piece of material, forming the fluid inlet port 228 and shaping the outer surface of the tube 212. The valve seat 232 may be formed in any one of numerous manners, such as, for example, grinding, using a wire EDM process, milling, turning, or any other suitable methods of machining. It will be appreciated that the particular manner by which the valve seat 232 is formed may be dependent on its particular desired shape. The fluid inlet port 228 may also be formed in any manner. Moreover, in an embodiment in which more than one fluid inlet port 228 is to be implemented into the valve seat section 216, the fluid inlet ports 228 may each be formed using substantially identical methods, or alternatively, different methods. The outer surface of the tube 212 is shaped into an appropriate configuration for coupling to the valve housing 113. In this regard, the outer surface may be shaped by grinding, using a wire EDM process, or the like. In another exemplary embodiment, the outer surface is formed by using a wire EDM process, similar to the process described above. In such case, it will be understood that the outer surface of the valve seat section 216 will have a multi-faceted surface. In still another exemplary embodiment, the multi-faceted valve seat section 216 outer surface is grinded down to a smooth surface.

As briefly mentioned above, a wire electric discharge machine is used to shape a second section of the outer surface of the first piece of material between the valve seat section 216 and a second end of the first piece of material into the blast tube section 218 (506). In one exemplary embodiment, first, the wire is used to remove a first section of the outer surface. Then, the tube 212 is rotated and the wire is then used to remove a next section of the outer surface. This process is repeated until the entire outer surface resembles a desired shape. It will be understood that as a result of using a wire EDM process, the outer surface of the tube will be faceted. Alternatively, if desired, the tube outer surface may be grinded to obtain a smooth surface.

In configurations in which the tube 212 is inserted into the nozzle 214, a second end of the first piece of material opposite the valve seat 232 is formed into a mating end that has a shape suitable for mating with the nozzle 214. It will be appreciated that the second end may be shaped using in any one of numerous manners, including, but not limited to, grinding, using wire EDM, milling, turning, or any other suitable manners for machining a component.

Next, the nozzle 214 is coupled to the mating end of the first piece of material (508). The nozzle 214 may be obtained off the shelf or specially manufactured. In one exemplary embodiment in which the nozzle 214 is manufactured, first, a second piece of is obtained for constructing the nozzle 214. Preferably, the second piece of material is made of material that is similar to the first piece of material; however, any other material capable of maintaining structural integrity upon exposure to temperatures of above 3700° F. may be used as well. In one example, the second piece of material is a rhenium alloy. The second piece of material is then formed into the nozzle 214 using any one of numerous effective manners. For example, a wire EDM process, plunge EDM process, or grinding may be employed. For a wire EDM process, a start hole is formed through the second piece of material. Then, a wire is threaded through the start hole. The wire is coupled to an electric discharge machine to supply electric current thereto and the wire is then used to carve the nozzle flow path. As illustrated in FIG. 2, the nozzle flow path is preferably cone-shaped. In the case in which the tube 212 is mated with the nozzle 214, an inlet end of the nozzle flow path is shaped to mate with the tube 212 by any suitable method, such as, for example, grinding, and an EDM process. In other exemplary embodiments, lower structural requirements may be acceptable for the nozzle 214 and thus, may be manufactured using CVD or electroplating processes.

After the nozzle 214 is obtained, it is coupled to the tube 212. As stated above, the tube 212 may be inserted into the nozzle 214. Alternatively, the nozzle 214 may be inserted into the tube 212. The nozzle 214 and tube 212 may be coupled in any one of numerous manners in which a leak tight joint is created, for example, by welding, press fit, or diffusion bonding.

It will be appreciated that in other embodiments, the steps described above may be performed in any logical sequence.

There has now been provided a fluidic diverter valve that has a simple design and is structurally robust. Additionally, a method for manufacturing the valve has been provided that is not relatively simple, efficient and inexpensive to employ.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A thruster for use with a fluidic diverter valve, the fluidic diverter valve having a valve housing, the thruster comprising:
a first tube having a first end, a second end, and an outer surface, the first tube first end configured to be disposed within the valve housing and the outer surface having a valve seat section and a blast tube section, the valve seat section adapted to couple to the valve housing and the blast tube section configured to extend outside of the valve housing;
a valve seat integrally formed on the first tube first end; and
a flow path extending between the first tube first and second ends.

2. The thruster of claim 1, further comprising a separately manufactured nozzle coupled to the tube second end, the nozzle having a funnel-shaped flow path extending therethrough in communication with the flow path.

3. The thruster of claim 2, wherein the tube and nozzle comprise material having a porosity level capable of preventing pressure loss when sealed and pressurized with at least 1000 psi of nitrogen gas and capable of maintaining structural integrity when exposed to temperatures of at least about 3,700° F.

4. The thruster of claim 3, wherein the material comprises a rhenium alloy.

5. The thruster of claim 1, wherein the outer surface blast tube section is facetted.

6. A hot gas fluidic diverter valve, comprising:
a valve housing having a cavity formed therethrough; and
a thruster coupled to the valve housing, the thruster comprising:
a first tube having a first end, a second end, and an outer surface, the first tube first end disposed within the valve housing cavity and the outer surface having a valve seat section and a blast tube section, the valve seat section coupled to the valve housing and the blast tube section extending outside of the valve housing;
a valve seat integrally formed on the first tube first end,
a flow path extending between the first tube first and second ends; and
a separately manufactured nozzle coupled to the first tube second end, the nozzle having a funnel-shaped flow path extending therethrough in communication with the first tube flow path.

7. The diverter valve of claim 6, further comprising:
a second thruster coupled to the valve housing, the second thruster comprising:
a second tube having a first end, a second end, and an outer surface, the tube first end disposed within the valve housing cavity and the outer surface having a valve seat section and an blast tube section, the valve seat section coupled to the valve housing and the blast tube section extending outside of the valve housing;
a valve seat formed on the second tube first end,
a flow path extending between the second tube first and second ends; and
a nozzle coupled to the tube second end, the nozzle having a funnel-shaped flow path extending therethrough in communication with the second tube flow path.

8. The diverter valve of claim 6, further comprising:
a valve element cavity defined by the valve housing, first tube first end, and second tube first end.

9. The diverter valve of claim 8, further comprising a valve element freely disposed within the valve element cavity and translationally moveable in response to hot gas flow into the valve housing to move between at least the first tube valve seat and second tube valve seat.

10. The diverter valve of claim 9, wherein the first tube valve seat and second tube valve seat are positioned substantially opposite the valve element cavity from one another.

11. A method for manufacturing a thruster for coupling to a valve housing, comprising:
forming a flow path through a first piece of material;
shaping a first section of an outer surface of the first piece of material proximate a first end of the first piece of material to form a valve seat section configured to couple to the valve housing;
using a wire discharge machine to shape a second section of the outer surface of the first piece of material between the valve seat section and a second end of the first piece of material into a blast tube section; and
coupling a nozzle to the second end of the first piece of material.

12. The method of claim 11, wherein the step of coupling a nozzle comprises:
forming a funnel-shaped flow path through a second piece of material; and
shaping an outer surface of the second piece of material using a wire electro-discharge machine to form a nozzle.

13. The method of claim 12, wherein the step of forming a funnel-shaped flowpath comprises forming a start hole through the second piece of material, threading a wire through the start hole and using an electro-discharge machine coupled to the wire to form the funnel-shaped flowpath.

14. The method of claim 13, wherein the step of forming a start hole comprises using a plunge tool to form the start hole.

15. The method of claim 12, wherein the step of forming a funnel-shaped flowpath comprises grinding the second piece of material.

16. The method of claim 11, wherein the step of coupling a nozzle further comprises:
forming a leak-tight joint between the nozzle and the second end of the first piece of material.

17. The method of claim 16, wherein the step of coupling a nozzle further comprises:
welding the nozzle to the second end of the first piece of material.

18. The method of claim 11, wherein the steps of forming, shaping, and using, each further comprise using a piece of material having a porosity level capable of preventing pressure loss when sealed and pressurized with at least 1000 psi of nitrogen gas and capable of maintaining structural integrity when exposed to temperatures of at least about 3,700° F.

19. The method of claim 18, wherein the step of using a piece of material further comprises using a rhenium alloy.

20. The method of claim 11, wherein the step of forming a flow path comprises forming a start hole through the first piece of material.
